(19) United States
(12) Patent Application Publication
(10) Pub. No.: US 2021/0275908 A1
(43) Pub. Date: Sep. 9, 2021

(54) ADAPTING ENCODER RESOURCE ALLOCATION BASED ON SCENE ENGAGEMENT INFORMATION

(71) Applicants: Advanced Micro Devices, Inc., Santa Clara, CA (US); ATI Technologies ULC, Markham (CA)

(72) Inventors: Ihab AMER, Markham (CA); Thomas PERRY, Bellevue, WA (US); Mehdi SAEEDI, Markham (CA); Guennadi RIGUER, Markham (CA); Gabor SINES, Markham (CA); Yang LIU, Markham (CA)

(21) Appl. No.: 17/193,788

(22) Filed: Mar. 5, 2021

Related U.S. Application Data
(60) Provisional application No. 62/985,544, filed on Mar. 5, 2020.

(51) Int. Cl. A63F 13/25; G06T 7/90; G06T 7/11; G06T 7/215

(52) U.S. Cl. CPC A63F 13/25; G06T 7/215; G06T 7/11; G06T 7/90

(57) ABSTRACT

An engagement analytics engine of a computing device analyzes one or more of scene representations, player inputs, or player meta information and generates corresponding engagement data indicative of a level of engagement corresponding to the represented scene. The engagement analytics engine generates encoding parameters based on the engagement data to cause scenes or regions within scenes to be encoded with a level of quality based on the indicated level of engagement. In some examples, the engagement analytics engine generates rendering parameters based on the engagement data to cause scenes to be rendered with a frame rate or quality parameters based on the indicated level of engagement. In some examples, the engagement analytics engine causes a load balancer to shift workloads associated with one or more scenes to higher or lower performance servers based on the engagement data.

### BACKGROUND

Computer systems, video game consoles, and other systems that present images to a user often employ an encoder to encode one or more streams of images. Encoding is useful, for example, to compress the stream of images to conserve bandwidth when transmitting an image over a network or other connection. However, compression generally impacts image quality, with higher levels of compression sometimes having a higher quality impact. A typical encoder employs a set of programmable factors, referred to as encoding parameters, that govern the level of compression for the image streams. However, conventional techniques for setting the encoding parameters sometimes result in the encoder consuming a relatively large amount of resources, such as network bandwidth, without a commensurate benefit in user satisfaction when viewing the image stream.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an illustrative computer networking system that includes a streamer device having an engagement analytics engine configured to generate engagement data indicative of a level of engagement of one or more scenes corresponding to a game application, and to allocate encoding resources based on the level of engagement, in accordance with some embodiments.

FIG. 2 is an illustrative scene representation depicting a low engagement region and a high engagement region identified by an engagement analytics engine, in accordance with some embodiments.

FIG. 3 is a block diagram of an illustrative computing device having an engagement analytics engine configured to generate engagement data indicative of a level of engagement of one or more scenes corresponding to a game application, and to allocate encoding resources based on the level of engagement, in accordance with some embodiments.

FIG. 4 is a block diagram illustrating various types of engagement data generated by an engagement analytics engine, in accordance with some embodiments.

FIG. 5 is a flow diagram illustrating a method for generating a compressed bitstream based on high engagement regions and low engagement regions of a scene, in accordance with some embodiments.

FIG. 6 is a flow diagram illustrating a method for generating a compressed bitstream based on temporal importance of a scene, in accordance with some embodiments.

FIG. 7 is a flow diagram illustrating a method for generating a compressed bitstream based on rendering parameters that are generated based on a level of player engagement associated with the scene, in accordance with some embodiments.

FIG. 8 is a block diagram of an illustrative computer networking system that includes a streamer device communicatively coupled to a server having an engagement analytics engine configured to generate engagement data indicative of a level of engagement of one or more scenes corresponding to a game application, where a load balancer is configured to shift workloads associated with the one or more scenes between servers based on the engagement data, in accordance with some embodiments.

FIG. 9 is a flow diagram illustrating a method for assigning workloads associated with a video stream to higher performance or lower performance servers based on an aggregate engagement score indicative of a level of engagement with the video stream, in accordance with some embodiments.

### DETAILED DESCRIPTION

In typical computing systems and computer networking systems, the demand for resources, such as bandwidth, bitrate, or processing power, is typically higher than the resources available to such systems, and therefore resources are allocated based on a resource prioritization scheme. Embodiments provided herein relate to computing systems that prioritize the allocation of encoding resources, such as encoding parameters for encoding video data, rendering parameters for rendering virtual scenes (e.g., corresponding to game applications), and server load balancing, based on one or more expected levels of engagement associated with the video data being encoded.

For example, in some embodiments, a computing system (e.g., corresponding to a server or a streamer device) includes an engagement analytics engine that analyzes rendered scenes of a game application, player inputs provided to the game application, or player meta information associated with the player to generate engagement data indicative of one or more levels of engagement (e.g., importance to a player or viewer) associated with the rendered scenes, the player, or both. The engagement analytics engine generates one or more of encoding parameters and rendering parameters that determine the quality with which scenes are rendered and encoded by the computing system, with scenes associated with higher levels of engagement being rendered and encoded with higher quality, and scenes associated with lower levels of engagement being rendered and encoded with lower quality. In this way, fewer resources of the computing system and, in some instances, a computer networking system that includes the computing system are used when encoding, rendering, and transmitting scenes that are expected to have lower levels of engagement, such that more resources of the computing system and computer networking system are available for encoding, rendering, and transmitting scenes expected to have higher levels of engagement.

In some embodiments, a load balancer is configured to reassign workloads associated with a particular video stream to servers having higher or lower performance based on levels of engagement indicated by the engagement data generated by the engagement analytics engine. For example, workloads corresponding to lower expected levels of engagement are reassigned to be processed by lower performance, but relatively more cost-efficient, servers, while workloads corresponding to higher expected levels of engagement are reassigned to be processed by higher performance servers having better processing capabilities, higher bandwidth, or lower latency, but are relatively less cost-efficient. In this way, resources of higher performance servers are less likely to be wasted on workloads having low levels of engagement (e.g., workloads corresponding to video of a player waiting in a lobby for a matchmaking process to complete), and more resources of such higher performance servers are available to process workloads with higher expected levels of engagement (e.g., corresponding to videos of active gameplay by a player).

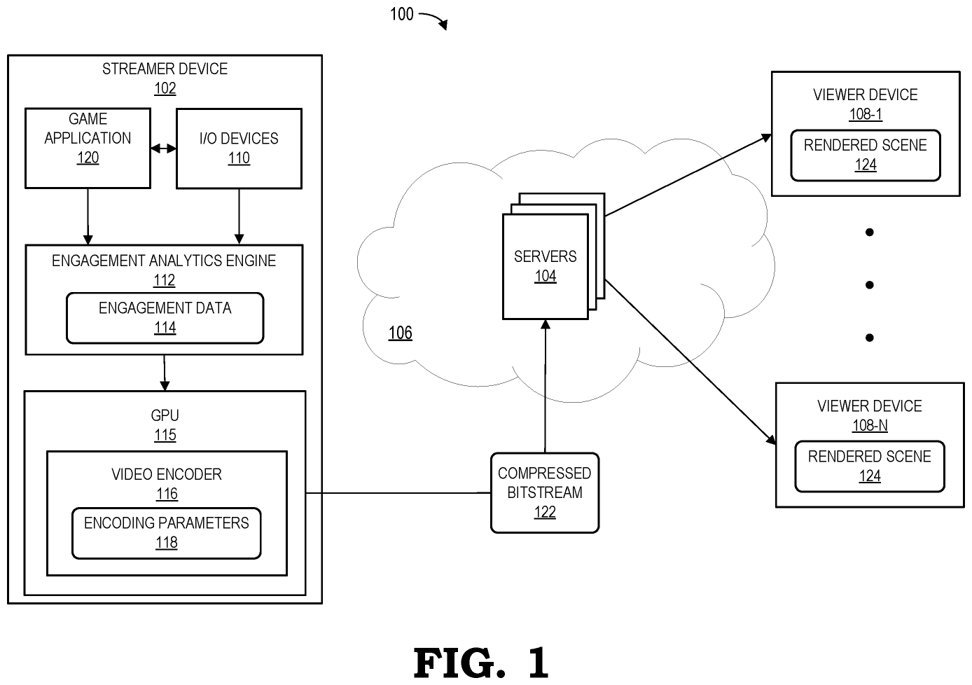

FIG. 1 illustrates a computer networking system 100 that includes a streamer device 102, one or more servers 104 included in a cloud network 106, and N viewer devices 108. In some embodiments, the streamer device 102 is configured to stream real-time or near-real-time gameplay video of a player (i.e., a user of the streamer device 102) to the servers 104 (via the internet) as a compressed bitstream 122, and the servers 104 are configured to distribute the gameplay video to multiple view devices 108 (via the internet). As described further herein, the streamer device 102 is configured to encode rendered scenes of the gameplay video based on an analysis of a level of engagement associated with objects within each scene, with an entire scene, with a sequence of scenes, or with the player associated with the scene or sequence of scenes. In this way, the streamer device 102 encodes scenes or portions of scenes that are expected, based on the analysis, to have a lower level of engagement with encoding parameters corresponding to lower quality (e.g., lower bitrate, lower fidelity, etc.) in order to better preserve the limited resources (generally, bits) available for encoding, and the streamer device 102 encodes scenes or portions of scenes that are expected to have a higher level of engagement with encoding parameters corresponding to higher quality (e.g., higher bitrate, higher fidelity, etc.), such that more resources (bits) of the video encoding are allocated to scenes that are expected to be more engaging to players and viewers.

The streamer device 102 is a computing system, such as a personal computer, smartphone, gaming console, or tablet. The streamer device 102 includes one or more input/output (I/O) devices 110, an engagement analytics engine 112 configured to generate engagement data 114, and a graphics processing unit (GPU) 115 having a video encoder 116 configured to encode image data based on encoding parameters 118. While the video encoder 116 is included in the GPU 115 in the present example, it should be understood that in other embodiments the video encoder 116 is separate from the GPU 115. In the present example, the streamer device 102 executes a game application 120, which generates gameplay audio data and video data based on software instructions associated with the game application 120 and based on player command inputs provided to the game application 120 via the I/O devices 110. The video data (sometimes referred to herein as “gameplay video data”) associated with the game application 120 is generally a sequence of scene representations, such as a sequence or set of two-dimensional (2D) or three-dimensional (3D) images (sometimes referred to as image frames) of a sequence of scenes. In some embodiments, scene representations that use 3D images to represent scenes of the game application 120 include depth information, such as a z-buffer, in addition to each rendered 3D image frame. In some embodiments, such scene representations additionally or alternatively include 3D positioning data (e.g., generated by the game application 120) indicative of the respective positions of game objects within the scene.

According to various embodiments, the I/O devices 110 include one or more of a keyboard, a mouse, a game controller, a camera, a motion detector, or a microphone. For example, command inputs provided by the player via the keyboard, mouse, or game controller are provided to the game application 120, allowing the player to interact with a virtual environment of the game application 120 (e.g., to interact with the scene depicted in the video data associated with the game application 120). As another example, video and audio data (sometimes referred to herein as “player video data” and “player audio data”) captured by a camera and microphone of the I/O devices 110 are provided to the engagement analytics engine 112, the video encoder 116, or both.

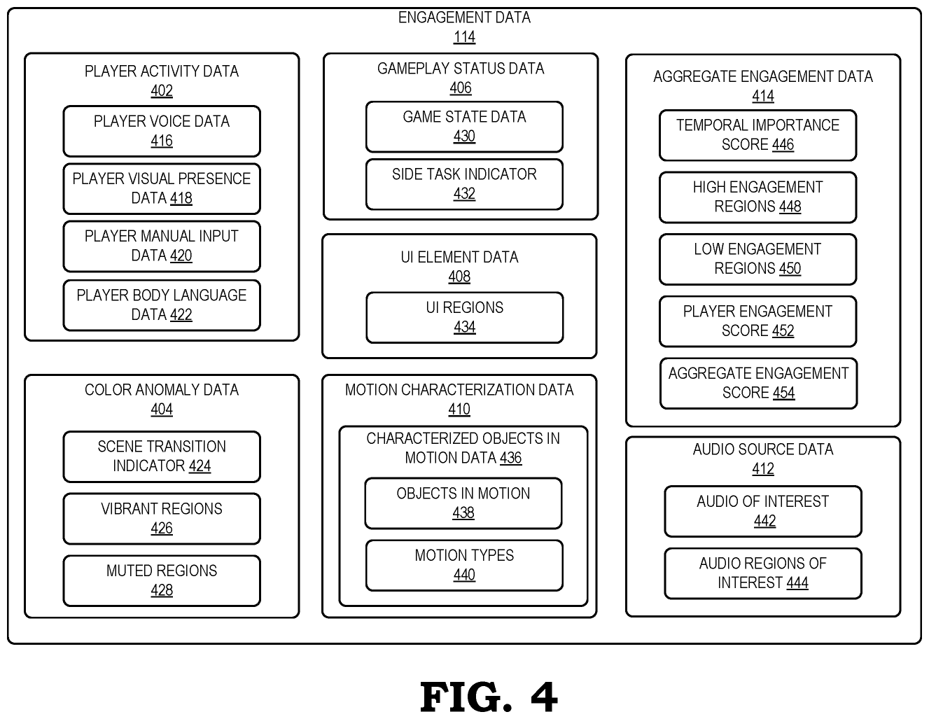

The engagement analytics engine 112 is configured to generate engagement data 114 for one or more scenes rendered at the streamer device 102. In some embodiments, the engagement analytics engine is at least partially software-implemented, with functions of the engagement analytics engine 112 being performed by a computer processor of the streamer device 102 based on computer-readable instructions stored at a memory of the streamer device 102. The engagement data 114 is indicative of a level of engagement (or, in some cases, an expected level of engagement) associated with such scenes. According to various embodiments, the engagement analytics engine 112 is configured to generate the engagement data 114 for a given scene based on one or more of a scene representation corresponding to that scene, player inputs (provided via the I/O devices 110), or player meta information retrieved from a remote database (e.g., via the internet). According to various embodiments, the engagement data 114 includes one or more of player activity data indicative of levels of engagement associated with a player's voice, presence manual inputs, or body language, color anomaly data indicative of scene transitions, vibrant regions within a scene, or muted regions within a scene, gameplay status data indicative of a game state of a game being streamed by the player or of the player being engaged in a side task, user interface element data indicative of user interface regions within a scene, motion characterization data indicative of objects in motion over a sequence of scenes characterized by their respective motion types and corresponding levels of engagement, audio source data indicative of audio of interest and regions from which such audio of interest is sourced in the scene, and aggregate engagement data indicative of the temporal importance a scene, high or low engagement regions within a scene, an overall level of player engagement, and an overall (aggregate) level of engagement of a player and a scene. Detailed examples of information that, in some embodiments, is included in the engagement data 114 are provided below in the example of FIG. 4.

Upon generating the engagement data 114 for a given scene (based on a scene representation of that scene), the engagement analytics engine 112 analyzes the engagement data 114 to determine encoding parameters 118 to be applied by the video encoder 116 when encoding the scene after the scene has been rendered (e.g., by the GPU 115). According to various embodiments, the video encoder 116 is configured to perform variable bitrate (VBR), constant bitrate (CBR), or quality-defined variable bitrate (QVBR) encoding of image frames. In some embodiments, such as those in which the video encoder 116 performs frame-level variable bitrate (VBR) encoding, the encoding parameters 118 include a quantization parameter (QP) to be used when encoding a given rendered scene (i.e., when encoding the image frame representing that scene). In some embodiments, such as those in which the video encoder 116 performs macroblock (MB)-level VBR encoding, the encoding parameters 118 include a set of QP values to be used when encoding each respective MB within a given rendered scene. In some embodiments, such as those in which the video encoder 116 performs constant bitrate (CBR) encoding, the encoding parameters 118 include a target bitrate to be used when encoding each rendered scene. In some embodiments, such as those in which the video encoder 116 performs quality-defined variable bitrate (QVBR) encoding, the encoding parameters 118 include a QVBR quality level and a maximum peak bitrate for encoding a sequence of rendered scenes. For video streaming applications, VBR or QVBR encoding is typically used. Herein, the term “bitrate” refers to the number of bits used per second to represent video or audio after encoding. In the context of video streaming, a higher bitrate typically corresponds to less compression, and results in higher quality images when reproducing the video data, but also results in larger video file sizes and requires more bandwidth in order to transmit the bitstream containing the video data to servers and viewer devices (such as the servers 104 and viewer devices 108). For example, in response to determining, based on the engagement parameters 114, that a scene or region within a scene corresponds to a relatively high level of engagement, the engagement analytics engine 112 sets encoding parameters 118 that causes the scene or region to be encoded with a relatively lower level of compression (e.g., by setting one or more of a low QP value, a high QVBR quality level, or a high bitrate for encoding the scene or region). As another example, in response to determining, based on the engagement parameters 114, that a scene or region within a scene corresponds to a relatively low level of engagement, the engagement analytics engine 112 sets encoding parameters 118 that causes the scene or region to be encoded with a relatively higher level of compression (e.g., by setting one or more of a high QP value, a low QVBR quality level, or a low bitrate for encoding the scene or region). In this way the streamer device 102 sets the quality of an encoded image (the encoded image representing a scene associated with the game application 120, in the present example) or region of an encoded image, based on an expected level of engagement for that image or region, thus improving the overall user experience.

The video encoder 116 encodes rendered scenes according to the corresponding encoding parameters 118 generated by the engagement analytics engine to produce encoded rendered scenes. It should be understood that the encoding of the rendered scenes by the video encoder 116 compresses the rendered scenes. The video encoder 116 then generates a compressed bitstream that includes the encoded rendered scenes. The video encoder 116 sends the compressed bitstream 122 to the servers 104 (e.g., via the internet). The servers 104 distributes the encoded rendered scenes to the viewer devices 108, which decode the encoded rendered scenes such that corresponding rendered scenes 124 are displayed at the viewer devices 108. The viewer devices include computing systems such as smartphones, tablets, personal computers, gaming consoles, smart televisions and the like. As an example, a sequence of rendered scenes of gameplay video corresponding to the game application 120 are streamed to the viewer devices 108 using a dynamic encoding scheme that is based on one or more indicators of the level of engagement of one or more of rendered scenes of the sequence, the indicators of the level of engagement corresponding to the engagement data 114 generated by the engagement analytics engine 112.

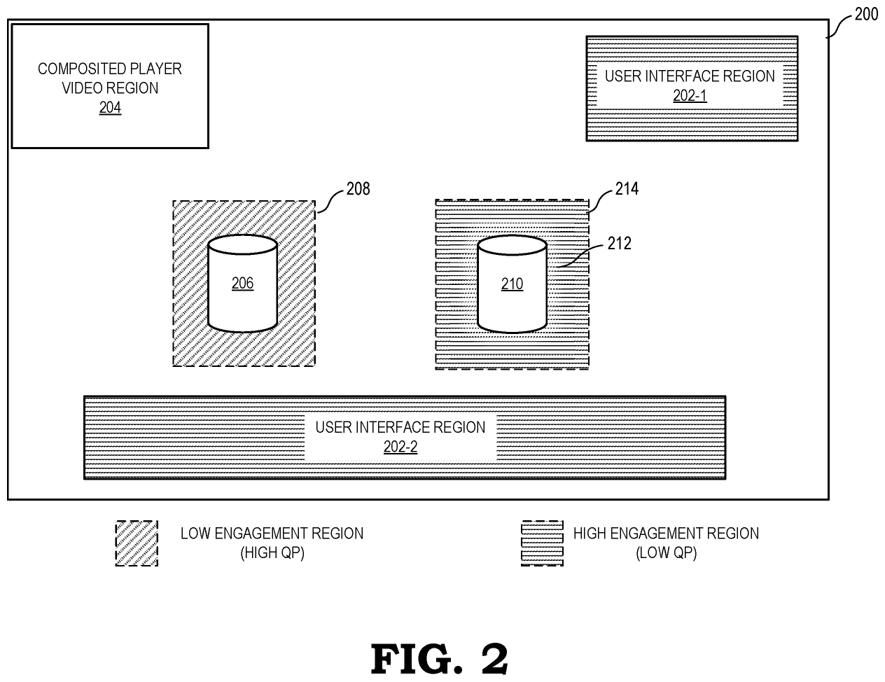

FIG. 2 illustrates an illustrative rendered scene 200 in which high engagement and low engagement regions have been identified by the engagement analytics engine 112 of FIG. 1. The rendered scene 200 includes user interface (UI) regions 202-1 and 202-2, a composited player video region 204, an engaging object 206, and a non-engaging object 210.

The UI regions 202-1 and 202-2 each include one or more UI elements. In some examples, such UI elements include one or more of maps, action bars, character status information (e.g., health, energy, mana, etc.), scoring information, and the like. Typically, such UI elements need to be encoded with high fidelity in order to be consistently readable, but undergo limited motion, such that the UI elements tend to remain in the same region of the scene, regardless of other changes occurring in the scene. Accordingly, in some embodiments, the engagement analytics engine 112 is configured to detect the UI regions 202 and to categorize or otherwise identify the UI regions 202 as being high engagement regions. In some embodiments, the game application 120 sends the engagement analytics engine 112 information identifying the locations of the UI regions 202. In other embodiments, the engagement analytics engine 112 identifies the UI regions 202 using one or more machine learning models that are trained to identify UI elements or regions, convolutional filters that are configured to identify UI elements or regions, or object identification algorithms that are configured to identify UI elements or regions.

In some embodiments, player video data depicting a player (i.e., user) that is interacting with the game application 120 is composited over corresponding gameplay video. In the present example, the rendered scene 200 (e.g., via a camera of the I/O devices 110) is provided in the composited player video region 204 that includes a frame of such player video data. In this way, a viewer of the rendered scene 200 is able to view both the player video and the gameplay video in the same rendered scene. In some embodiments, subregions of the composited player video region 204 are identified as low engagement regions or high engagement regions. In some embodiments, for example, the engagement analytics engine 112 identifies a subregion of the composited player video region 204 corresponding to the face of the player as a high engagement region. In some embodiments, for example, the engagement analytics engine 112 identifies a subregion of the composited player video region 204 corresponding to a static or substantially static background around the player as a low engagement region. In some such embodiments, the engagement analytics engine 112 identifies the face of the player or the background around the player using one or more trained machine learning models, convolutional filters, or object identification algorithms.

In the present example, a low engagement object 206 and a high engagement object 210 are present in the rendered scene 200. In an example, the engagement analytics engine 112 determines that the low engagement object 206 is expected to have low engagement and that the high engagement object 210 is expected to have high engagement based on their respective colorations. In some embodiments, the engagement analytics engine 112 is configured to identify objects with muted coloration (e.g., having low brightness or including a limited variety of colors) as corresponding to low expected engagement and objects with vibrant coloration (e.g., having high brightness or including a wider variety of colors). In some embodiments, the engagement analytics engine 112 is configured to identify objects having a halo or aura (e.g., a brightly colored halo or aura) about them, such as the aura 212 about the high engagement object 210, as having high expected engagement, as many games include such halos or auras about objects of interest (e.g., interactable objects, quest objects, important non-player characters, hostile enemy characters, and the like). In some such embodiments, the engagement analytics engine 112 identifies engagement-related attributes of the low engagement object 206 and the high engagement object 210 using one or more trained machine learning models, convolutional filters, object identification algorithms, or temporal analysis algorithms (which analyze motion of objects over multiple sequential image frames).

In the present example, after determining the engagement levels of the low engagement object 206 and the high engagement object 210, the engagement analytics engine 112 identifies a region 208, in which the low engagement object 206 is disposed, as being a low engagement region and identifies a region 214, in which the high engagement region is disposed, as being a high engagement region.

It should be understood, in some embodiments, that the engagement analytics engine 112 is configured to identify other aspects of a region in a given rendered scene or sequence of rendered scenes as having high or low expected levels of engagement. According to various examples, aspects corresponding to high expected levels of engagement include high dynamic action within a given region over a sequence of frames, important animating effects (sometimes indicated by visual effects (VFX) or particle systems) occurring in a given region, or audio of interest occurring in a given region (e.g., with such audio of interest sometimes being characterized as loud or inconsistent sound tending to orient the attention of a player or viewer).

In some embodiments, such as those in which the video encoder 116 is configured for MB-level VBR encoding, when generating the encoding parameters 118 the engagement analytics engine 112 is configured to generate encoding parameters that cause the identified low engagement regions to be encoded with relatively lower quality (e.g., lower fidelity) and that cause identified high engagement regions to be encoded with relatively higher quality (e.g., higher fidelity).

An example of an encoding parameter 118 that affects the quality or fidelity with which an image frame or other scene representation, or a region thereof, is encoded is the quantization parameter. For example, regions (e.g., MBs) of an image frame that are encoded with very low QP values retain almost all of their original spatial detail but require a larger number of bits to encode resulting in an overall higher bitrate for the image frame. In contrast, regions of an image frame that are encoded with comparatively higher QP values have their detail aggregated, requiring fewer bits to encode those regions and resulting in an overall lower bitrate for the image frame, but at the cost of some loss of quality (i.e., some loss of original spatial detail) and an increase in distortion of the region. Thus, by encoding low engagement regions with higher QP values and high engagement regions with lower QP values, the quality of more engaging regions of an image frame is retained, while the quality of less engaging regions of the image frame is reduced (e.g., offsetting, to some extent, the increased quality and bitrate allocation of the high engagement regions).

Another example of an encoding parameter 118 that affects the quality or fidelity of an image frame or other scene representation, or a region thereof, that is processed by the encoder 116 are filtering parameters, which indicate how a filtering algorithm, if any, is to be applied to the image frame or other scene representation, or a region thereof, prior to encoding at the encoder 116. In some embodiments, the engagement analytics engine 112 sets the filtering parameters based on the level of engagement indicated by the engagement data 114. In some examples, filtering algorithms are applied differently (e.g., with a different set of filtering parameters) to low engagement regions of an image frame prior to encoding compared to how the filtering algorithms are applied to high engagement regions prior to encoding, such that the quality and fidelity of more engaging regions of an image frame better preserved, while the quality of less engaging regions of the image frame is reduced (e.g., offsetting, to some extent, the increased quality and bitrate allocation of the high engagement regions).

While QP values and filtering parameters have been provided as illustrative examples of the encoding parameters 118 generated by the engagement analytics engine 112, it should be understood that, in some embodiments, additional or alternative encoding parameters 118 are generated by the engagement analytics engine 112, which affect either or both of the spatial and temporal quality and fidelity of encoded image frames or other scene representations, or regions thereof.

In the present example, the engagement analytics engine 112 generates the encoding parameters 118 such that the video encoder 116 encodes the UI regions 202 and the high engagement region 214 with relatively higher quality and fidelity (e.g., with higher bit rate) and encodes the low engagement region 208 with a relatively lower quality and fidelity (e.g., with lower bitrate).

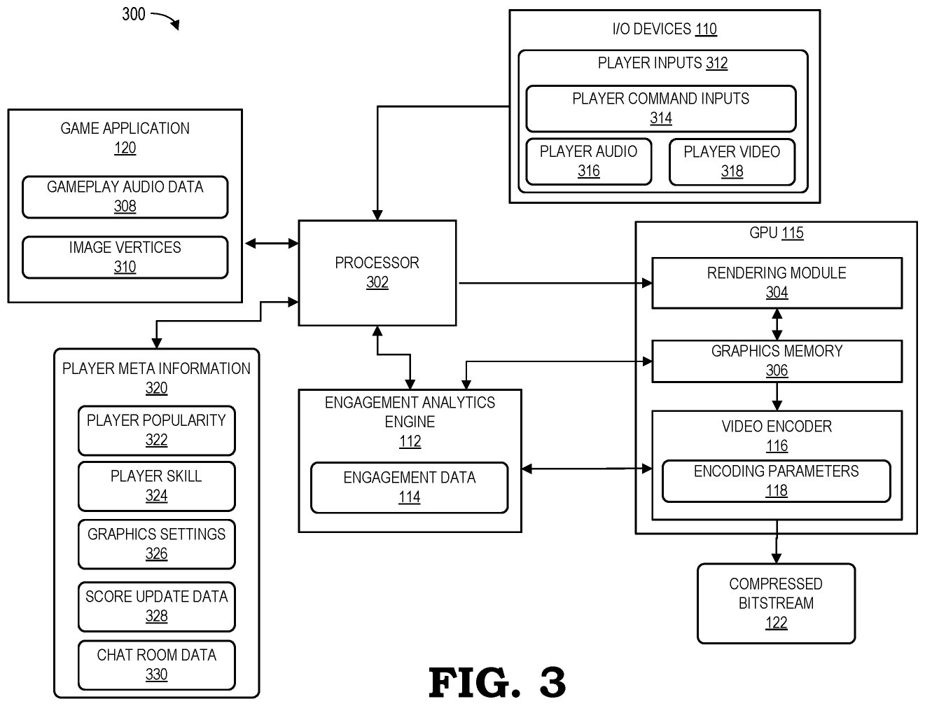

FIG. 3 illustrates a computing system 300 (such as the streamer device 102 of FIG. 1) which includes the I/O devices 110, the engagement analytics engine 112, the GPU 115, and a processor 302 (e.g., a computer hardware processor). In the present example, the GPU 115 includes a rendering module 304, a graphics memory 306, and the video encoder 116. The computing system 300 executes a game application 120 which, in conjunction with the processor 302, generates gameplay audio data 308 and image vertices 310 corresponding to scenes of the game application 120.

The GPU 115, and specifically the rendering module 304, receives image vertices 310 from the game application 120 and renders the vertices to generate rendered scenes (e.g., as a sequence of image frames), which are stored in the graphics memory 306. The video encoder 116 encodes the rendered scenes based on the encoding parameters 118, as described previously, some or all of which are generated by the engagement analytics engine 112 based on the engagement data 114. The encoded rendered scenes generated by the video encoder 116 are output as part of the compressed bitstream 122. While the video encoder 116 is included in the GPU 115 in the present example, it should be understood that in other embodiments the video encoder 116 is separate from the GPU 115.

As described previously, according to various embodiments, the I/O devices 110 include one or more of a keyboard, a mouse, a game controller, a camera, a motion detector, or a microphone. Player inputs 312 are provided via the I/O devices 110, and include player command inputs 314, player audio 316, and player video 318. For example, player command inputs 314 are provided by the player via a keyboard, mouse, or game controller of the I/O devices 110 and are provided to the game application 120, allowing the player to interact with a virtual environment of the game application 120 (e.g., to interact with the scene depicted in the video data associated with the game application 120). As another example, the player audio data 316 is recorded by a microphone of the I/O devices 110 and player video data 318 is recorded by a camera of the I/O devices 110. The player audio data 316 and the player video data 318 are provided (e.g., via the processor 302) to the engagement analytics engine 112, the video encoder 116, or both. In some embodiments, the GPU 115 of the streamer device 102 composites the player video data 314 with the gameplay video data (i.e., rendered scenes derived from the image vertices 310), such that in a given rendered scene, an image frame of the player video data 318 is overlaid (e.g., after being reduced in size) on top of the rendered scene (e.g., in a defined composited player video region of the rendered scene), such as in the composited player video region 204 of FIG. 2. In some embodiments, the player audio data 316 is combined with the gameplay audio data 308 associated with the game application 120. In some embodiments, some or all of the player inputs 312 are analyzed by the engagement analytics engine 112 to assess a level of player engagement, where indicators of the level of player engagement are included in the engagement data 114.

In some embodiments, the computing system 300 receives player meta information 320, which includes one or more of player popularity data 322, player skill data 324, graphics settings data 326, score update data 328, and chat room data 330. In an example, some or all of the player meta information 320 is received by the computing system 300 via one or more remote databases (e.g., via the internet) and is stored at a memory device or storage device of the computing system 300. In some embodiments, the identity of the player interacting with the game application 120 is determined (e.g., by the engagement analytics engine 112) based on a username or other identifier that the player uses to access the game application 120 or a streaming channel associated with a video streaming application being executed at the computing system 300, and the retrieved player meta information 320 corresponds to the identified player.

In some embodiments, the player popularity data 322 includes at least one of an indication of a historical number of viewers of video streams made by the identified player (e.g., via a streaming channel associated with the player by which viewers are able to access video data being streamed by the player live or recorded video data of the player), a number of likes received by videos or posts on the player's streaming channel, a number of accounts following the player's streaming channel, a number of accounts subscribed to the player's streaming channel, and a number of shares of videos or posts on the players streaming channel. In some embodiments, the indication of the historical number of viewers of the player's video streams includes or is an aggregate of one or more of an average number of viewers of all live video streams made by the player via the player's streaming channel, a total number of viewers of all video streams made by the player via the player's streaming channel, and an average or a total number of viewers for video streams made by the player via the player's streaming channel for a particular game (e.g., the game corresponding to the game application 120) or genre of games or during a defined time period. Generally, a higher number of viewers of the player's streams is indicative of higher player popularity, and higher player popularity is indicative of more engagement. That is, since more viewers are expected to stream gameplay video from a popular player, it is generally desirable to provide higher quality encoding and to use higher performance servers for streaming gameplay video for that popular player, while less popular players generally require lower quality encoding and lower performance servers for streaming their gameplay video. Accordingly, in some embodiments, the engagement analytics engine 112 generates the encoding parameters 118 based at least in part on the player popularity data 322, such that the encoding parameters 118 cause the video encoder 116 to encode rendered scenes with comparatively higher quality and bitrate for players with higher numbers of viewers and, therefore, higher indicated popularity. In some embodiments, the engagement analytics engine 112 generates the encoding parameters 118 based at least in part on the player popularity data 322, such that the encoding parameters 118 cause the video encoder 116 to encode rendered scenes with comparatively lower quality and lower bitrate for players with lower numbers of viewers and, therefore, lower indicated popularity. In some embodiments, the engagement analytics engine 112, based at least in part on the player popularity data 322 of a player, causes a higher performance server (e.g., one or more of having higher graphics processing capabilities, better bandwidth, lower latency, closer geographic proximity to the streamer device, etc.) to handle workloads associated with streaming gameplay video when the player is indicated to have a higher number of viewers. In some embodiments, the engagement analytics engine 112, based at least in part on the player popularity data 322 of a player, causes a lower performance server (e.g., having one or more of lower graphics processing capabilities, less bandwidth, higher latency, less geographic proximity to the streamer device, etc.) to handle workloads associated with streaming gameplay video when the player is indicated to have a lower number of viewers.

In some embodiments, the player skill data 324 includes one or more objective scores indicative of how skilled the player is at one or more games (e.g., the game corresponding to the game application 120). Generally, a player with a higher skill level is expected to be more popular, and higher player popularity is indicative of more engagement. That is, more viewers are expected to stream gameplay video from a more skilled player, so it is generally desirable to provide higher quality encoding and to use higher performance servers for streaming gameplay video for a more skilled player, while less skilled players generally require lower quality encoding and lower performance servers for streaming their gameplay video. Accordingly, in some embodiments, the engagement analytics engine 112 generates the encoding parameters 118 based at least in part on the player skill data 324, such that the encoding parameters 118 cause the video encoder 116 to encode rendered scenes with comparatively higher quality and bitrate for players with higher skill levels (e.g., with respect to at least the game application 120) and, therefore, higher expected popularity. In some embodiments, the engagement analytics engine 112 generates the encoding parameters 118 based at least in part on the player skill data 324, such that the encoding parameters 118 cause the video encoder 116 to encode rendered scenes with comparatively lower quality and lower bitrate for players with lower skill levels and, therefore, lower expected popularity. In some embodiments, the engagement analytics engine 112, based at least in part on the player skill data 324 of a player, causes a higher performance server (e.g., one or more of having higher graphics processing capabilities, better bandwidth, lower latency, closer geographic proximity to the streamer device, etc.) to handle workloads associated with streaming gameplay video when the player is indicated to be more skilled. In some embodiments, the engagement analytics engine 112, based at least in part on the player popularity skill 324 of a player, causes a lower performance server (e.g., having one or more of lower graphics processing capabilities, less bandwidth, higher latency, less geographic proximity to the streamer device, etc.) to handle workloads associated with streaming gameplay video when the player is indicated to be less skilled.

In some embodiments, the graphics settings 326 includes a player-defined indication of whether the player prioritizes high performance (e.g., less lag, better frame rate) or high quality when streaming video data. In some embodiments, the engagement analytics engine 112 generates the encoding parameters 118 based at least in part on the graphics settings 326, such that the encoding parameters 118 cause the video encoder 116 to encode rendered scenes with comparatively higher quality and bitrate when the graphics settings 326 indicate high quality prioritization, and to encode rendered scenes with comparatively lower quality and bitrate resulting in better performance (e.g., higher frame rate, less lag, fewer dropped frames, etc.) when the graphics settings 326 indicate high performance prioritization.

In some embodiments, the score update data 328 includes one or more historical rates or aggregate historical rates at which the player's score is updated for one or more games (e.g., the game corresponding to the game application 120). Generally, a player with a higher score update rate is expected to be more popular, and higher player popularity is indicative of more engagement. That is, more viewers are expected to stream gameplay video from a player with a higher score update rate, so it is generally desirable to provide higher quality encoding and to use higher performance servers for streaming gameplay video for a player with more frequent score updates, while players with less frequent score updates generally require lower quality encoding and lower performance servers for streaming their gameplay video. Accordingly, in some embodiments, the engagement analytics engine 112 generates the encoding parameters 118 based at least in part on the score update data 328, such that the encoding parameters 118 cause the video encoder 116 to encode rendered scenes with comparatively higher quality and bitrate for players with higher score update rates (e.g., with respect to at least the game application 120) and, therefore, higher expected popularity. In some embodiments, the engagement analytics engine 112 generates the encoding parameters 118 based at least in part on the score update data 328, such that the encoding parameters 118 cause the video encoder 116 to encode rendered scenes with comparatively lower quality and lower bitrate for players with lower score update rates and, therefore, lower expected popularity. In some embodiments, the engagement analytics engine 112, based at least in part on the score update data 328 of a player, causes a higher performance server (e.g., one or more of having higher graphics processing capabilities, better bandwidth, lower latency, closer geographic proximity to the streamer device, etc.) to handle workloads associated with streaming gameplay video when the player is indicated to have a higher score update rate. In some embodiments, the engagement analytics engine 112, based at least in part on the score update data 328 of a player, causes a lower performance server (e.g., having one or more of lower graphics processing capabilities, less bandwidth, higher latency, less geographic proximity to the streamer device, etc.) to handle workloads associated with streaming gameplay video when the player is indicated to have a lower score update rate.

In some embodiments, the chat room update data 330 includes one or more historical rates or aggregate historical rates at which a chat room associated with the player's streaming channel is updated (e.g., at which new chat messages are submitted to the chat room by viewers or by the player). Generally, a player with a higher chat room update rate is expected to be more popular, and higher player popularity is indicative of more engagement. For example, if the chat room associated with a player's stream(s) is frequently updated due to high message volume in the chat room, this is indicative of high levels of engagement and activity of the viewers and the player themselves. Players having a higher chat room update rate are typically more engaged and active and have viewers that are more engaged and active, so it is generally desirable to provide higher quality encoding and to use higher performance servers for streaming gameplay video for a player with more frequent chat room updates, while players with less frequent chat room updates generally require lower quality encoding and lower performance servers for streaming their gameplay video. Accordingly, in some embodiments, the engagement analytics engine 112 generates the encoding parameters 118 based at least in part on the chat room update data 330, such that the encoding parameters 118 cause the video encoder 116 to encode rendered scenes with comparatively higher quality and bitrate for players with higher chat room update rates (e.g., with respect to at least the player's gameplay video streams corresponding to the game application 120) and, therefore, higher expected popularity. In some embodiments, the engagement analytics engine 112 generates the encoding parameters 118 based at least in part on the chat room update data 330, such that the encoding parameters 118 cause the video encoder 116 to encode rendered scenes with comparatively lower quality and lower bitrate for players with lower chat room update rates and, therefore, lower expected popularity. In some embodiments, the engagement analytics engine 112, based at least in part on the chat room update data of a player, causes a higher performance server (e.g., one or more of having higher graphics processing capabilities, better bandwidth, lower latency, closer geographic proximity to the streamer device, etc.) to handle workloads associated with streaming gameplay video when the player is indicated to have a higher chat room update rate. In some embodiments, the engagement analytics engine 112, based at least in part on the chat room update data 330 of a player, causes a lower performance server (e.g., having one or more of lower graphics processing capabilities, less bandwidth, higher latency, less geographic proximity to the streamer device, etc.) to handle workloads associated with streaming gameplay video when the player is indicated to have a lower chat room update rate.

In the present example, the engagement analytics engine 112 receives rendered scenes from the GPU 115, the player inputs 312 from the I/O devices 110, and the player meta information 320. The engagement analytics engine 112 analyzes one or more of the rendered scenes, the player inputs 312, and the player meta information to generate the engagement data 114, which is indicative of one or more levels of engagement associated with a given scene, individual regions within the scene, or the player. The engagement analytics engine 112 then generates encoding parameters 118 based on the engagement data 114, the encoding parameters 118 controlling the bitrate and the quality with which corresponding rendered scenes are encoded. In some embodiments, the engagement analytics engine 112 also causes a load balancer to select, based on the engagement data 114, which of the servers 104 processes workloads associated with distribution of the compressed bitstream 122 (and the constituent encoded rendered scenes) to the viewer devices 108.

FIG. 4 illustrates an example of various information generated by the engagement analytics engine 112 as part of the engagement data 114. In the present example, the engagement analytics engine 114 includes player activity data, color anomaly data, gameplay status data, UI element data 408, motion characterization data 410, audio source data 412, and aggregate engagement data 414.

The player activity data includes player voice data 416, player visual presence data 418, player manual input data 420, and player body language data 422.

In some embodiments, the engagement analytics engine 112 generates the player voice data 416 by applying a speech filter to the player audio data 316 received from the I/O devices 110. In some embodiments, the player voice data 416 includes audio representing the player's speech isolated from some or all other sounds in the player audio data 316. In some embodiments, the player voice data 416 is indicative of a rate or volume at which the player is speaking, with faster or louder speech typically corresponding to higher levels of player engagement, infrequent or soft speech typically corresponding to lower levels of player engagement, and complete absence of speech over a long period being associated with a lack of player presence and, therefore, low player engagement. In some embodiments, the player voice data 416 is indicative of one or more predefined keywords detected in the player's speech that are associated with high or low levels of engagement (with the engagement analytics engine 112 identifying such keywords in the isolated player's speech via one or more natural language processing algorithms, for example). For example, in response to determining that the player voice data 416 is indicative of one or both of a high rate or high volume of player speech, or includes at least a predefined number of keywords associated with higher levels of engagement, the engagement analytics engine 112 generates encoding parameters 118 that cause corresponding rendered scenes to be encoded with higher quality and higher bitrate. For example, in response to determining that the player voice data 416 is indicative of one or both of a low rate or low volume of player speech, or includes more than a predefined number of keywords associated with lower levels of engagement, the engagement analytics engine 112 generates encoding parameters 118 that cause corresponding rendered scenes to be encoded with lower quality and lower bitrate. For example, in response to determining that the player voice data 416 indicates an absence of player speech over a defined period (indicating that the player is absent), the engagement analytics engine 112 generates encoding parameters 118 that cause the corresponding rendered scenes to be encoded with a lower bitrate and, in some instances, generates rendering parameters of the GPU 115 such that the GPU 115 renders such scenes with a reduced frame rate or other reductions in quality (e.g., turning off one or more of anti-aliasing, anisotropic filtering, motion blur, film grain, depth of field, or chromatic aberration when rendering the scenes).

In some embodiments, the engagement analytics engine 112 generates the player visual presence data 418 based on the player video data 318 received from the I/O devices 110. For example, the engagement analytics engine 112 analyzes the player video data 310 to determine whether a person (e.g., the player) is present in the scene represented in the player video data 310. In some embodiments, the player visual presence data indicates either that the player is not present in the player video represented by the player video data 310 (corresponding to lower player engagement), or that the player is present in the player video (corresponding to higher player engagement). For example, in response to determining that the player visual presence data 418 indicates that a person is not present in the player video data 310, the engagement analytics engine 112 generates encoding parameters 118 that cause the corresponding rendered scenes to be encoded with a lower bitrate and, in some instances, generates rendering parameters of the GPU 115 such that the GPU 115 renders such scenes with a reduced frame rate or other reductions in quality (e.g., turning off one or more of anti-aliasing, anisotropic filtering, motion blur, film grain, depth of field, or chromatic aberration when rendering the scenes).

In some embodiments, the engagement analytics engine 112 generates the player manual input data 420 based on the player command inputs 314. For example, the engagement analytics engine 112 analyzes the player command inputs 314 to determine a rate at which the player command inputs 314 are received via the I/O devices 110, with a high rate of player command inputs 314 corresponding to a higher level of player engagement and a higher level of scene engagement (e.g., due to more engaging scenes typically requiring more frequent command inputs from the player), a low rate of player command inputs 314 corresponding to a lower level of player engagement and a lower level of scene engagement, and an absence of player command inputs 314 being received over a defined period being one indicator of player absence, and therefore a low level of player engagement. For example, in response to determining that the player manual input data 420 indicates a relatively high rate of received player command inputs, the engagement analytics engine 112 generates encoding parameters 118 that cause corresponding rendered scenes to be encoded with higher quality and a higher bitrate. For example, in response to determining that the player manual input data 420 indicates a relatively low rate of received player command inputs, the engagement analytics engine 112 generates encoding parameters 118 that cause corresponding rendered scenes to be encoded with lower quality and a lower bitrate. For example, in response to determining that the player manual input data 420 indicates an absence of player command inputs 314 over a defined period (indicating that the player is absent), the engagement analytics engine 112 generates encoding parameters 118 that cause the corresponding rendered scenes to be encoded with a lower bitrate and, in some instances, generates rendering parameters of the GPU 115 such that the GPU 115 renders such scenes with a reduced frame rate or other reductions in quality (e.g., turning off one or more of anti-aliasing, anisotropic filtering, motion blur, film grain, depth of field, or chromatic aberration when rendering the scenes).

In some embodiments, the engagement analytics engine 112 generates the player body language data 422 based on the player video data 318. For example, the engagement analytics engine 112 analyzes the player video data 318 using one or more trained machine learning models, convolutional filters, object identification algorithms, or temporal analysis algorithms to determine the player's emotional state (e.g., neutral, happy, angry, excited, afraid, etc.) based on their facial expression and, in some instances, posture. More extreme emotional states (i.e., with greater deviation from neutral) typically indicate a need for high performance. For example, in response to determining that the player body language data 422 indicates such extreme emotional states, the engagement analytics engine 112 generates encoding parameters 118 that cause corresponding rendered scenes to be encoded with higher quality and a higher bitrate. For example, in response to determining that the player body language data 422 indicates less extreme emotional states (closer to neutral), the engagement analytics engine 112 generates encoding parameters 118 that cause corresponding rendered scenes to be encoded with lower quality and a lower bitrate.

The color anomaly data includes a scene transition indicator 424 and defines vibrant regions 426 and muted regions 428 that the engagement analytics engine 112 has identified within a given scene. In some embodiments, the engagement analytics engine 112 generates the scene transition indicator 424 based on a determination of whether a scene transition is occurring in a scene or a sequence of scenes. In some embodiments, the engagement analytics engine 112 determines that a scene transition is occurring by identifying a change in color of most or all regions between one rendered scene and the next sequential rendered scene. In some instances, scene transitions extend over multiple sequential image frames. In some embodiments, the engagement analytics engine 112 identifies a scene transition using one or more trained machine learning models or temporal analysis algorithms. For example, the quality of a given scene is typically less important during scene transitions, since the expected level of engagement for the scene during scene transitions is low. Accordingly, in some embodiments, in response to determining that the scene transition indicator 424 indicates that a rendered frame corresponds to a scene transition, the engagement analytics engine 112 generates encoding parameters 118 that cause the rendered scene to be encoded with a lower bitrate and lower quality.

In some embodiments, the engagement analytics engine 112 identifies the vibrant regions 426 by processing the rendered scene with one or more trained machine learning models or convolutional filters. For example, such trained machine learning models or convolutional filters identify regions of the rendered image having vibrant coloration (e.g., having high brightness or including a wider variety of colors) as vibrant regions 426. In some embodiments, such trained machine learning models or convolutional filters process the rendered scene in combination with one or more object identification algorithms to identify objects having a halo or aura (e.g., a brightly colored halo or aura) about them as vibrant regions 426. Typically, the vibrant regions 426 tend to orient a viewer's attention due to their vibrant coloration, and therefore correspond to a higher expected level of engagement. Accordingly, in some embodiments, the engagement analytics engine 112 generates encoding parameters 118 that cause the vibrant regions 426 to be encoded with higher quality (e.g., higher fidelity) and a higher contribution to the bitrate of the rendered scene.

In some embodiments, the engagement analytics engine 112 identifies the muted regions 428 by processing the rendered scene with one or more trained machine learning models or convolutional filters. For example, such trained machine learning models or convolutional filters identify regions of the rendered image having muted coloration (e.g., having low brightness or including a limited variety of colors) as muted regions 428. Typically, the muted regions 428 tend to be less important and are less likely to orient a viewer's attention due to their muted coloration, and therefore correspond to a lower expected level of engagement. Accordingly, in some embodiments, the engagement analytics engine 112 generates encoding parameters 118 that cause the muted regions 428 to be encoded with lower quality (e.g., lower fidelity) and lower contributions to the bitrate of the rendered scene.

The gameplay status data 406 includes a game state data 430 and a side task indicator 432. In some embodiments, the engagement analytics engine 112 generates the game state data 430 based on at least one of analysis of rendered scenes associated with the game application 120, analysis of player command inputs 134, or analysis of game state information received from the game application 120. In an example, the engagement analytics engine 112 applies one or more trained machine learning models, convolutional filters, object identification algorithms, or temporal analysis algorithms to one or both of the rendered scenes or the player command inputs 314 to determine that the game state corresponds to a “matchmaking” state in which the player is waiting for completion of a multiplayer matchmaking process. Such matchmaking states are typically identifiable based on a sequence of rendered scenes remaining substantially static (e.g., with little to no motion occurring in the scenes) or based on features typical of matchmaking lobbies. In another example, the engagement analytics engine receives an indication of the games state from the game application 120, the indication defining whether the game application 120 is in the matchmaking state or in an “active” state in which the corresponding game is actively being played by the player. For example, in response to determining that the game state data 430 indicates that the game application 120 is in the matchmaking state, the engagement analytics engine 112 generates encoding parameters 118 that cause rendered scenes to be encoded with lower quality and lower bitrate during the matchmaking state. For example, in response to determining that the game state data 430 indicates that the game application 120 is in the active state, the engagement analytics engine 112 generates encoding parameters 118 that cause rendered scenes to be encoded with higher quality and higher bitrate during the active state.

The side task indicator 432 indicates whether the player is engaged in a side task that is separate from the game application 120. In some embodiments, the engagement analytics engine 112 generates the side task indicator 432 based on a determination of whether the player is engaged in a side game (e.g., while waiting for matchmaking in a primary game, such as an embodiment of the game application 120). In some embodiments, the engagement analytics engine 112 applies one or more trained machine learning models, convolutional filters, object identification algorithms or other image analysis algorithms to determine whether rendered scenes correspond to the game application 120, to a web browser, or to a secondary game that is separate from the game application 120. In some embodiments, the engagement analytics engine 112 analyzes the player command inputs 314 to determine that the player has switched from a window associated with the game application 120 to a different window, such as that of a web browser or a secondary game (each characterized herein as side tasks). In some embodiments, the engagement analytics engine 112 determines the game state data 430 based, at least in part, on the side task indicator 432 indicating that the player is engaged in a side task (e.g., indicating that the game state is likely not the active state). In some embodiments, in response to determining that the side task indicator 432 indicates that the player is engaged in a side task, the engagement analytics engine 112 generates encoding parameters 118 that cause rendered scenes to be encoded with lower quality and lower bitrate while the player is engaged in the side task.

The UI element data 408 defines UI regions 434 that the engagement analytics engine 112 has identified within a given rendered scene. In some embodiments, the UI regions 434 include UI elements such as maps, action bars, character status information (e.g., health, energy, mana, etc.), scoring information, and the like. In some embodiments, the engagement analytics engine 112 identifies the UI regions 434 by processing the rendered scene with one or more trained machine learning models, convolutional filters, object identification algorithms, or temporal analysis algorithms. For example, the engagement analytics engine 112 identifies regions of the rendered scene that undergo limited or no motion across a sequence of rendered scenes (e.g., in which other objects in the rendered scenes are undergoing motion) as being UI regions 434. In some embodiments, the game application 120 provides an indication of locations of the UI regions 434 to the engagement analytics engine 112. Typically, the UI regions 434 need to be encoded with high fidelity in order to be consistently readable. Accordingly, in some embodiments, the engagement analytics engine 112 generates encoding parameters 118 that cause the UI regions 434 of rendered scenes to be encoded with higher quality (e.g., higher fidelity) and higher contributions to the bitrate of the rendered scene.

The motion characterization data 410 includes characterized objects in motion data 436 defining objects in motion in a rendered scene or sequence of scenes that the engagement analytics engine 112 has identified as having a high level of engagement, based on its motion type. The characterized objects in motion data 436 defines identified objects in motion 438 in the scene or sequence of scenes and respective motion types 440 for each of the identified objects in motion 438.

In some embodiments, the engagement analytics engine 112 identifies the objects in motion 438 and their corresponding motion types 440 over a sequence of rendered scenes using one or more trained machine learning models, convolutional filters, object identification algorithms, or temporal analysis algorithms. Generally, certain motion types of the motion types 440 are more likely to correspond to high levels of engagement than others. In some examples, motion types 440 associated with high levels of engagement include visual effects (VFX) motion and particle systems motion. For example, motion corresponding to VFX or particle systems is often indicative of the activation of character abilities that typically result in damage or other effects to a player's characters and are therefore associated with high levels of engagement. In some embodiments, one or more of the motion types 440 is indicative of character animations, corresponding to motion of an object in the scene or sequence of scenes, where the object has been identified as a character (e.g., based on analysis by one or more object identification algorithms, trained machine learning algorithms, convolutional filters, or the like executed via the engagement analytics engine 112). Generally, character animations are of high importance to a player or viewer, and it is desirable to encode corresponding objects (characters) with higher quality and fidelity (e.g., higher bit rates). For example, the character animation motion type of the motion types 440 is indicative that a corresponding object in motion is a character, and the engagement analytics engine identifies the corresponding object as a high-engagement object. In some embodiments, the characterized objects in motion data 436 indicate a level of engagement for each of the objects in motion 438 based on the motion types 440. In some embodiments, the engagement analytics engine 112 generates encoding parameters 118 that cause regions associated with relatively high-engagement objects of the objects in motion 438 (e.g., as indicated by the characterized objects in motion data 436) to be encoded with higher quality (e.g., higher fidelity) and higher contributions to the bitrate of the rendered scene.

The audio source data 412 includes audio of interest 442 and defines corresponding audio regions of interest 444. In some embodiments, the engagement analytics engine 112 isolates the audio of interest 442 from the gameplay audio data 308 by using one or more trained machine learning models or audio analysis algorithms to analyze the gameplay audio data 308 to identify and extract audio of the gameplay audio data 308 associated with high engagement. In some embodiments, the engagement analytics engine 112 identifies audio of the gameplay audio data 308 that is relatively loud or inconsistent as being high engagement audio (e.g., with loud or inconsistent sounds typically tending to orient the attention of a player or viewer) and identifies such high engagement audio as audio of interest 442.

In some embodiments, the engagement analytics engine 112 identifies the audio regions of interest 444 based on the audio of interest 442. For example, (e.g., for embodiments in which the audio of interest 442 includes two-dimensional (2D) stereo sound or three-dimensional (3D) positional sound) in response to determining that a given region of a rendered scene corresponds to the source of the audio of interest 442, the engagement analytics engine 112 identifies the region as an audio region of interest 444. In some embodiments, the engagement analytics engine 112 generates encoding parameters 118 that cause the audio regions of interest 444 to be encoded with higher quality (e.g., higher fidelity) and higher contributions to the bitrate of the rendered scene.

The aggregate engagement data 414 includes a temporal importance score 446, high engagement regions 448, low engagement regions 450, a player engagement score 452, and an aggregate engagement score 454. The temporal importance score 446 is indicative of a level of temporal importance of a given rendered scene or sequence of rendered scenes, which sometimes corresponds to a level of dynamic action and the presence of important animating effects therein. In some embodiments, the engagement analytics engine 112 generates the temporal importance score 446 for a given rendered scene based on the characterized objects in motion data 436. For example, the engagement analytics engine 112 generates a higher temporal importance score 446 for rendered scenes indicated as having relatively many (e.g., more than a predetermined threshold number) high-engagement objects in motion, thus corresponding to high dynamic action. For example, the engagement analytics engine 112 generates a lower temporal importance score 446 for rendered scenes indicated as having relatively few (e.g., less than a predetermined threshold number) high-engagement objects in motion, thus corresponding to low dynamic action. For example, the engagement analytics engine 112 generates a higher temporal importance score 446 for rendered scenes having objects in motion 438 with particular motion types 440 that associated with important animating effects, such as those corresponding to VFX or particle systems. In some embodiments, the engagement analytics engine 112 generates encoding parameters 118 that cause rendered scenes having a higher temporal importance score 446 to be encoded with higher quality and higher bitrate. In some embodiments, the engagement analytics engine 112 generates encoding parameters 118 that cause rendered scenes having a lower temporal importance score 446 to be encoded with lower quality and lower bitrate.

The high engagement regions 448 correspond to regions of a given rendered scene that contain objects, colors, or other elements associated with high levels of engagement, as identified by the engagement analytics engine 112. In some embodiments, the engagement analytics engine 112 identifies the high engagement regions 448 as including one or more of the vibrant regions 426, regions that include high-engagement objects in motion as indicated by the characterized objects in motion data 436, the UI regions 434, or the audio regions of interest 444. In some embodiments, the engagement analytics engine 112 generates encoding parameters 118 that cause the high engagement regions 448 to be encoded with higher quality (e.g., higher fidelity) and higher contributions to the bitrate of the corresponding rendered scene.

The low engagement regions 450 correspond to regions of a given rendered scene that contain objects, colors, or other elements associated with low levels of engagement, as identified by the engagement analytics engine 112. In some embodiments, the engagement analytics engine 112 identifies the low engagement regions 450 as including one or more of the muted regions 428, or regions that include low-engagement objects in motion as indicated by the characterized objects in motion data 436. In some embodiments, the engagement analytics engine 112 generates encoding parameters 118 that cause the low engagement regions 450 to be encoded with lower quality (e.g., lower fidelity) and lower contributions to the bitrate of the corresponding rendered scene.

The player engagement score 452 indicates a level of player engagement with a given rendered scene or sequence of rendered scenes. In some embodiments, the engagement analytics engine 112 generates the player engagement score 452 based on one or both of the player activity data 402 and the gameplay status data 406. For example, the engagement analytics engine 112 generates a higher player engagement score 452 for a rendered scene in response to one or more of the following conditions: the player voice data 416 indicates a high rate or volume of player speech or high-engagement keywords, the player visual presence data 418 indicates the player is visually present in the player video data 318, the player manual input data 420 indicates a high rate of received player command inputs 314, the player body language data 422 indicates that the player's emotion is highly deviated from neutral, the game state data 430 indicates an active game state, and the side task indicator 432 indicates that the player is not engaged in a side task. For example, the engagement analytics engine 112 generates a lower player engagement score 452 for a rendered scene in response to one or more of the following conditions: the player voice data 416 indicates a low rate or volume of player speech or low-engagement keywords, the player visual presence data 418 indicates the player is not visually present in the player video data 318, the player manual input data 420 indicates a low rate of received player command inputs 314, the player body language data 422 indicates that the player's emotion is substantially neutral, the game state data 430 indicates a matchmaking game state, and the side task indicator 432 indicates that the player is engaged in a side task. In some embodiments, the engagement analytics engine 112 generates encoding parameters 118 that cause rendered scenes having a higher player engagement score 452 to be encoded with higher quality and higher bitrate. In some embodiments, the engagement analytics engine 112 generates encoding parameters 118 that cause rendered scenes having a lower player engagements core 452 to be encoded with lower quality and lower bitrate.

The aggregate engagement score 454 represents an overall level of engagement associated with a given rendered scene. In some embodiments, the engagement analytics engine 112 generates the aggregate engagement score 454 based one or more of the player activity data 402, the color anomaly data 404, the gameplay status data 406, the UI element data 408, the motion characterization data 410, the audio source data 412, and other elements of the aggregate engagement data 414. In some embodiments, the engagement analytics engine 112 further generates the aggregate engagement score 454 based on the player meta information 320, with higher player popularity indicated by the player popularity data 322, higher player skill indicated by the player skill data 324, more frequent score updates indicated by the score update data 328, and more frequent chat room updates indicated by the chat room update data 330 corresponding to a higher aggregate engagement score 454, and lower player popularity indicated by the player popularity data 322, lower player skill indicated by the player skill data 324, less frequent score updates indicated by the score update data 328, and less frequent chat room updates indicated by the chat room update data 330 corresponding to a lower aggregate engagement score 454. In some embodiments, the engagement analytics engine 112 causes a load balancer to select, based on the aggregate engagement score 454, which of the servers 104 processes workloads associated with distribution of the compressed bitstream 122 (and the constituent encoded rendered scenes) to the viewer devices 108. In some examples, the load balancer selects higher performance servers of the servers 404 to process the workload of the compressed bitstream 122 in response to determining that the aggregate engagement score 454 is high (e.g., higher than a first threshold), and selects lower performance servers of the servers 404 to process the workload of the compressed bitstream 122 in response to determining that the aggregate engagements core 454 is low (e.g., lower than a second threshold).

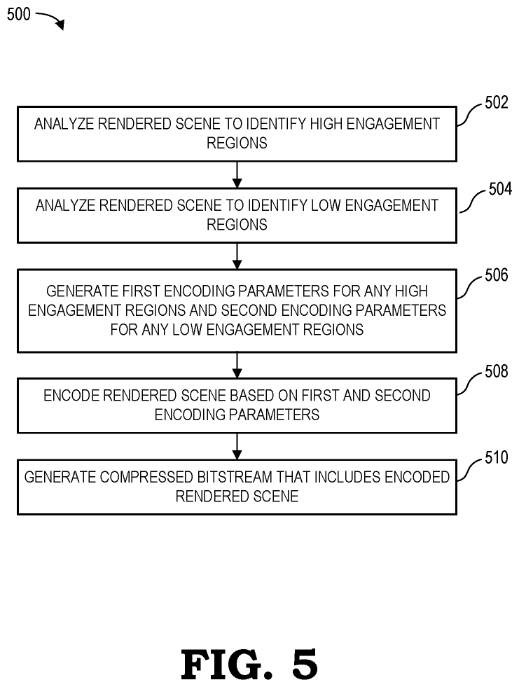

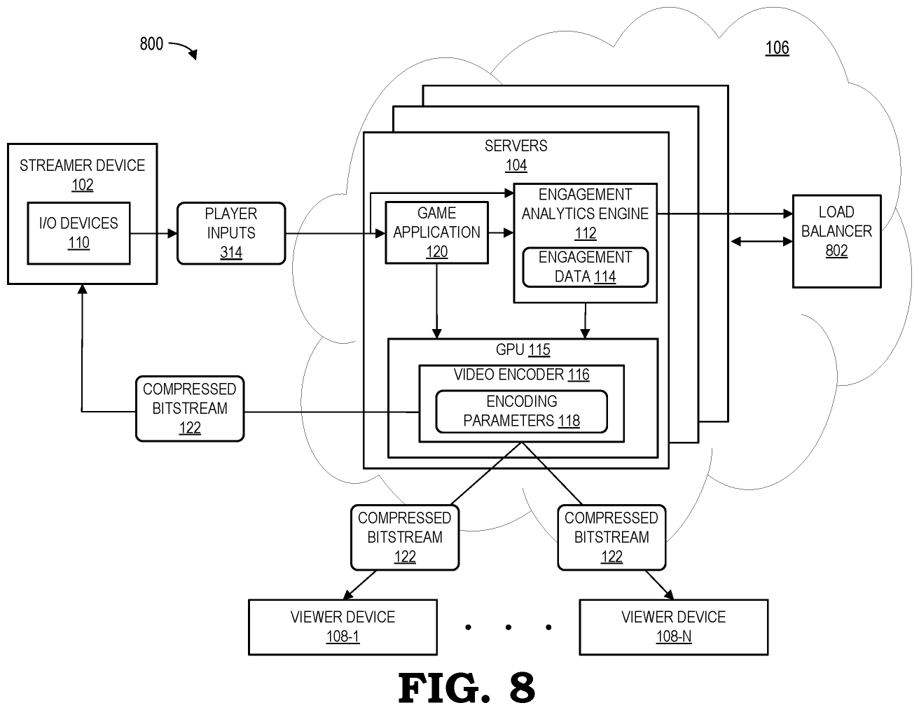

FIG. 5 is a flow diagram of a method 500 of encoding a rendered scene based on the identification of high engagement regions and low engagement regions within the rendered scene. The method 500 is implemented in some embodiments of the computer networking system 100 of FIG. 1, the computing system 300 of FIG. 3, and the computer networking system 800 of FIG. 8.

At step 502, the engagement analytics engine 112 analyzes a rendered scene to identify high engagement regions (such as UI regions 202 and high engagement region 214 of FIG. 2 and high engagement regions 448 of FIG. 4) within the rendered scene. In some embodiments, the engagement analytics engine 112 applies one or more trained machine learning models, convolution filters, object identification algorithms, and temporal analysis algorithms to identify the high engagement regions. In some embodiments, the engagement analytics engine 112 identifies the high engagement regions based on elements of the engagement data 114, such as the vibrant regions 426, UI regions 434, characterized objects in motion data 436, and audio regions of interest 444.

At step 504, the engagement analytics engine 112 analyzes the rendered scene to identify low engagement regions (such as low engagement region 208 of FIG. 2 and low engagement regions 450 of FIG. 4) within the rendered scene. In some embodiments, the engagement analytics engine 112 applies one or more trained machine learning models, convolution filters, object identification algorithms, and temporal analysis algorithms to identify the low engagement regions. In some embodiments, the engagement analytics engine 112 identifies the low engagement regions based on elements of the engagement data 114, such as the muted regions 428.

At step 506, the engagement analytics engine 112 generates first encoding parameters for any high engagement regions identified at step 502 and generates second encoding parameters for any low engagement regions identified at step 504. In some embodiments, the first encoding parameters cause the high engagement regions to be encoded with relatively higher spatial quality (e.g., higher spatial fidelity) and relatively high contribution to the bitrate, and the second encoding parameters cause the low engagement regions to be encoded with relatively lower spatial quality (e.g., lower spatial fidelity) and relatively lower contribution to the bitrate.

At step 508, the video encoder 116 encodes the rendered scene based on the first and second encoding parameters generated by the engagement analytics engine 112 to produce an encoded rendered scene.

At step 510, the video encoder 116 generates a compressed bitstream 122 that includes the encoded rendered scene. In some embodiments, the video encoder 116 outputs the compressed bitstream 122 to one or more servers 104 or viewer devices 108.

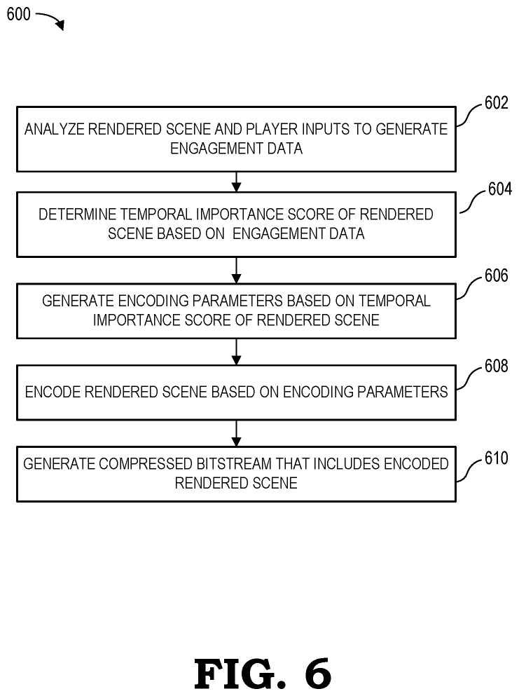

FIG. 6 is a flow diagram of a method 600 of encoding a rendered scene based on the temporal importance of the rendered scene. The method 600 is implemented in some embodiments of the computer networking system 100 of FIG. 1, the computing system 300 of FIG. 3, and the computer networking system 800 of FIG. 8.

At step 602, the engagement analytics engine 112 analyzes a rendered scene and corresponding player inputs 312 to generate engagement data 114. At step 604, the engagement analytics engine 112 determines a temporal importance score 446 for the rendered scene based on the engagement data 114. For example, the temporal importance score 446 of the rendered scene is indicative of a level of temporal importance of the rendered scene, which sometimes corresponds to a level of dynamic action and the presence of important animating effects therein. In some embodiments, the engagement analytics engine 112 generates the temporal importance score 446 for the rendered scene based on the characterized objects in motion data 436, as described above.

At step 606, the engagement analytics engine 112 generates encoding parameters 118 based on the temporal importance score 446 of the rendered scene. For example, if the engagement analytics engine 112 determines that temporal importance score 446 is indicative of the rendered scene having a high temporal importance (e.g., the temporal importance score 446 is above a predefined threshold value), then the engagement analytics engine 112 generates the encoding parameters 118 to cause the rendered scene to be encoded with a relatively higher bitrate and higher quality. For example, if the engagement analytics engine 112 determines that temporal importance score 446 is indicative of the rendered scene having a low temporal importance (e.g., the temporal importance score 446 is below a predefined threshold value), then the engagement analytics engine 112 generates the encoding parameters 118 to cause the rendered scene to be encoded with a relatively lower bitrate and lower quality.

At step 608, the video encoder 116 encodes the rendered scene based on the encoding parameters generated by the engagement analytics engine 112 to produce an encoded rendered scene.

At step 610, the video encoder 116 generates a compressed bitstream 122 that includes the encoded rendered scene. In some embodiments, the video encoder 116 outputs the compressed bitstream 122 to one or more servers 104 or viewer devices 108.

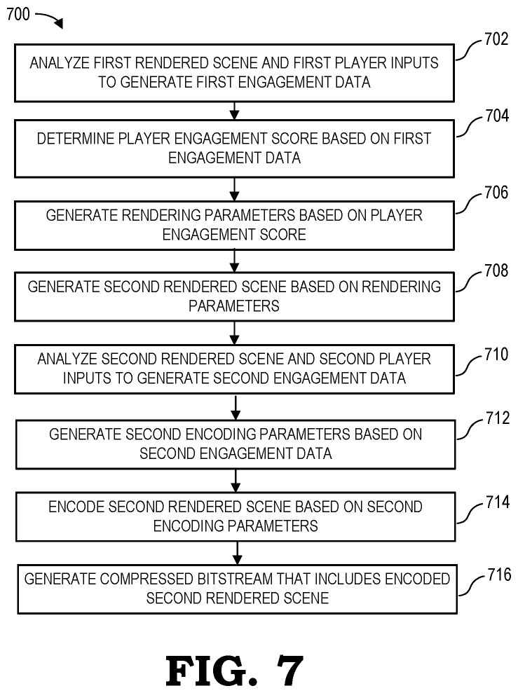

FIG. 7 is a flow diagram of a method 700 of encoding a rendered scene based on a determined level of player engagement with the rendered scene. The method 700 is implemented in some embodiments of the computer networking system 100 of FIG. 1, the computing system 300 of FIG. 3, and the computer networking system 800 of FIG. 8.

At step 702, the engagement analytics engine 112 analyzes a first rendered scene and corresponding first player inputs (such as an embodiment of the player inputs 312 of FIG. 3) provided by a player via the I/O circuitry 110 to generate first engagement data (such as an embodiment of the engagement data 114 of FIGS. 1, 3, and 4).

At step 704, the engagement analytics engine 112 determines a player engagement score 452 indicative of a level of engagement of the player with the rendered scene based on the first engagement data. In some embodiments, the engagement analytics engine 112 generates the player engagement score 452 based on one or both of the player activity data 402 and the gameplay status data 406, as described above.

At step 706, the engagement analytics engine 112 generates rendering parameters for a GPU 115 based on the player engagement score 452. For example, in response to determining that the player engagement score 452 indicates a low level of player engagement, the engagement analytics engine 112 generates the rendering parameters to provide a relatively lower frame rate at which scenes are rendered by the GPU 115 or modifies quality parameters of the GPU 115 by turning off one or more of anti-aliasing, anisotropic filtering, motion blur, film grain, depth of field, or chromatic aberration. For example, in response to determining that the player engagements core 452 indicates a high level of player engagement, the engagement analytics engine 112 generates the rendering parameters to provide a relatively higher frame rate at which scenes are rendered by the GPU 115 or modifies quality parameters of the GPU 115 by turning on one or more of anti-aliasing, anisotropic filtering, motion blur, film grain, depth of field, or chromatic aberration.

At step 708, the engagement analytics engine 112 generates a second rendered scene based on the rendering parameters generated by the engagement analytics engine 112.

At step 710, the engagement analytics engine 112 analyzes the second rendered scene and corresponding second player inputs (such as an embodiment of the player inputs 312 of FIG. 3) provided by the player via the I/O circuitry 110 to generate second engagement data (such as an embodiment of the engagement data 114 of FIGS. 1, 3, and 4).

At step 712, the engagement analytics engine 112 generates encoding parameters 118 based on the second engagement data and the player engagement score 452. For example, the engagement analytics engine 112 generates encoding parameters 118 that cause the second rendered scene to be encoded with a higher bitrate and higher quality (e.g., in response to determining that the second engagement data indicates a high level of engagement for the second rendered scene) or to be encoded with a lower bitrate and lower quality (e.g., in response to determining that the second engagement data indicates a low level of engagement for the second rendered scene).

At step 714, the video encoder 116 encodes the rendered scene based on the encoding parameters generated by the engagement analytics engine 112 to produce an encoded rendered scene.

At step 716, the video encoder 116 generates a compressed bitstream 122 that includes the encoded rendered scene. In some embodiments, the video encoder 116 outputs the compressed bitstream 122 to one or more servers 104 or viewer devices 108.

While, in the present example, the method 700 involves a comparison of the player engagement score 452 with one or more discrete thresholds, it should be understood that in other embodiments, the engagement analytics engine 112 generates the encoding parameters 118 based on a function (e.g., a linear function or a function of a trained machine learning model) that takes the player engagement score 452 as an input and provides, as an output, the encoding parameters 118 that cause corresponding rendered scenes to be encoded with high or low quality and high or low bitrate.

FIG. 8 illustrates a computer networking system 100 that includes a streamer device 102, one or more servers 104 included in a cloud network 106, and N viewer devices 108. In contrast to the previous example of the computer networking system 100 of FIG. 1 in which the engagement analytics engine 112 and corresponding video encoder 116 are included in the streamer device 102 that executes the game application 120, in the example of the computer networking system 800 of FIG. 8, one of the servers 104 includes the engagement analytics engine 112, the GPU 115, the video encoder 116, executes the game application 120, and is configured to render and encode scenes for the game application 120 based on the engagement data 114, as described above.

The server 104 receives the player inputs 312 (i.e., including one or more of the player command inputs 314, the player audio data 316, and the player video data 318) from the I/O devices 110 at the streamer device 102 via the internet. In some embodiments, server 104 composites the player video data 318 over rendered scenes of the game application 120. The server 104, upon rendering and encoding scenes of the game application 120, incorporates the encoded rendered scenes into the compressed bitstream 122 and sends the compressed bitstream 122 to the streamer device 102 and the viewer devices 108.

The computer networking system 800 further includes a load balancer 802. The load balancer 802 is communicatively coupled to the servers 104 and is configured to select individual servers of the servers 104 to process workloads. For example, the load balancer 802 is configured to select a server of the servers 104 to process workloads associated with executing the game application 120 and the engagement analytics engine 114, rendering and encoding corresponding scenes (e.g., image frames) and generating the compressed bitstream 122. In some embodiments, the servers 104 vary with respect to their achievable levels of performance, their geographic or temporal locations with respect to the streamer device 102, and cost efficiencies. In some embodiments, the load balancer 802 is configured to reassign the workloads associated with the game application 120 and the engagement analytics engine 112 based on the engagement data 114. In an example, the load balancer 802 is configured to reassign the workloads associated with the game application 120 and the engagement analytics engine 112 to a higher performance server (e.g., having better graphics processing capabilities, higher bandwidth, or lower latency) in response to determining that one or more elements of the engagement data 114 (e.g., the aggregate engagement score 454) indicate a higher level of engagement for such workloads. In an example, the load balancer 802 is configured to reassign the workloads associated with the game application 120 and the engagement analytics engine 112 to a lower performance server (e.g., having reduced graphics processing capabilities, lower bandwidth, or higher latency) in response to determining that one or more elements of the engagement data 114 (e.g., one or more of the aggregate engagement score 454, the game state data 430, the side task indicator 432, the player visual presence data 418, or the player manual input data 420) indicate a lower level of engagement for such workloads. For example, lower performance servers tend to be less expensive to use and operate than higher performance servers, so reassigning low-engagement workloads to lower performance servers improves the cost efficiency of streaming gameplay video with relatively little impact on the player's perceived experience.

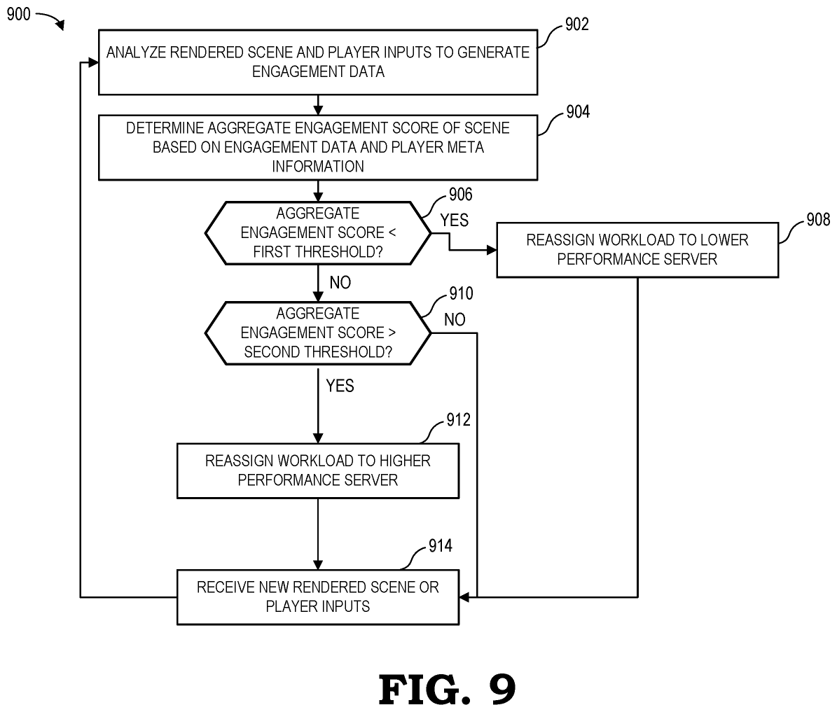

FIG. 9 is a flow diagram of a method 900 of performing server load balancing for processing workloads associated with a rendered scene based on an aggregate engagement score indicative of an aggregate level of engagement of the rendered scene. The method 900 is implemented in some embodiments of the computing system 300 of FIG. 3 and the computer networking system 800 of FIG. 8. While the present example involves reassigning workloads based on the aggregate engagement score, it should be understood that, in some embodiments, other elements of the engagement data 114 that are indicative of high or low levels of engagement are used instead in performing the method 900.

At step 902, the engagement analytics engine 112 analyzes a rendered scene and corresponding player inputs 312 to generate engagement data 114. At step 904, the engagement analytics engine 112 determines an aggregate engagement score 454 for the rendered scene based on one or both of the engagement data 114 and the player meta information 320. At step 906, the engagement analytics engine 112 determines whether the aggregate engagement score 454 is less than a first threshold value, indicating a low overall level of engagement associated with a workload corresponding to the rendered scene. If the aggregate engagement score 454 is less than the first threshold value, the method 900 proceeds to step 908. Otherwise, if the aggregate engagement score 454 is higher than the first threshold value, the method 900 proceeds to step 910.

At step 908, the engagement analytics engine 112 causes the load balancer 802 to reassign the workload associated with the rendered scene to a lower performance server of the servers 404 compared to the server that is presently processing the workload. In some examples, the lower performance server has one or more of reduced graphics processing capabilities, lower bandwidth, or higher latency compared to the server that is presently processing the workload. For example, by reassigning a workload associated with a low level of engagement, based on the aggregate engagement score 454, to a lower performance server, the cost efficiency of streaming corresponding gameplay video is reduced with, generally, relatively little impact on the player's perceived experience.

At step 910, the engagement analytics engine 112 determines whether the aggregate engagement score 454 is higher than a second threshold value, indicating a high overall level of engagement associated with a workload corresponding to the rendered scene. According to various embodiments, the second threshold value is higher than or equal to the first threshold value. In some embodiments, the first and second threshold values are determined dynamically, based on the level of performance of the server that is presently processing the workload associated with the rendered scene. If the aggregate engagement score 454 is higher than the second threshold value, the method 900 proceeds to step 912. Otherwise, if the aggregate engagement score 454 is less than the second threshold value, the method 900 proceeds to step 914.

At step 912, the engagement analytics engine 112 causes the load balancer 802 to reassign the workload associated with the rendered scene to a higher performance server of the servers 404 compared to the server that is presently processing the workload. In some examples, the higher performance server has one or more of better graphics processing capabilities, higher bandwidth, or lower latency compared to the server that is presently processing the workload. For example, by reassigning a workload associated with a high level of engagement, based on the aggregate engagement score 454, to a higher performance server, the quality of the gameplay video being streamed is improved, thereby generally improving the player's perceived experience.

At step 914, the engagement analytics engine 112 receives a new rendered scene or set of player inputs for analysis, then returns to step 902.

While in the present example, the method 900 involves comparison of the aggregate engagement score 454 with one or more discrete thresholds, it should be understood that in other embodiments, the engagement analytics engine 112 determines whether to reassign a workload to a higher or lower performance server based on a function (e.g., a linear function or a function of a trained machine learning model) that takes the aggregate engagement score 454 as an input and provides, as an output, an indication of workload reassignment to a higher or lower performance server or of no workload reassignment.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
generating encoding parameters for an encoder based on engagement data indicative of a level of engagement associated with a set of images; and
encoding the set of images at the encoder, the encoding based on the encoding parameters.

2. The method of claim 1, further comprising:
identifying a first high engagement region and a first low engagement region of the set of images based on the engagement data; and
wherein generating the encoding parameters comprises:
identifying a first set of encoding parameters for encoding the first high engagement region; and
identifying a second set of encoding parameters for encoding the first low engagement region, the first set of encoding parameters different than the second set of encoding parameters.

3. The method of claim 2, wherein the first set of encoding parameters correspond to higher fidelity encoding than the second set of encoding parameters.

4. The method of claim 2, wherein the first high engagement region and the first low engagement region are identified based on user interface element data of the engagement data, the user interface element data being indicative of at least one user interface region of the set of images, and wherein first low engagement region includes the user interface region.

5. The method of claim 2, wherein the first high engagement region and the first low engagement region are identified based on color anomaly data of the engagement data, the color anomaly data being indicative of at least one of: a vibrant region and a muted region, and wherein the first low engagement region includes the muted region, and the first high engagement region includes the vibrant region.

6. The method of claim 2, wherein the first high engagement region and the first low engagement region are identified based on motion characterization data of the engagement data, the motion characterization data being indicative of at least one moving object in the set of images having a motion type associated with high engagement, and wherein the first high engagement region includes the at least one moving object.

7. The method of claim 2, wherein the first high engagement region and the first low engagement region are identified based on audio source data of the engagement data, the audio source data being indicative of at least one audio region of interest, and wherein the first high engagement region include the at least one audio region of interest.

8. A system comprising:
an engagement analytics engine configured to:
generate encoding parameters based on engagement data indicative of a level of engagement associated with a set of images; and
a video encoder configured to:
encode the set of images based on the encoding parameters.

9. The system of claim 8, wherein the engagement analytics engine is further configured to:
determine, based on motion characterization data of the engagement data, a target bitrate for encoding the set of images, the encoding parameters comprising the target bitrate.

10. The system of claim 8, wherein the encoding parameters cause the set of images to be encoded with a level of fidelity that corresponds to the level of engagement indicated by the encoding parameters.

11. The system of claim 8, wherein the engagement data includes motion characterization data that is indicative of at least one of: a level of dynamic action in the set of images or at least one predefined animating effect in the set of images.

12. The system of claim 8, wherein the engagement analytics engine is further configured to generate the encoding parameters based on player activity data of the engagement data, the player activity data including at least one of: voice data corresponding to a user associated with the set of images, visual presence data indicative of the user being present in a video input received by the engagement analytics engine, manual input data indicative of a rate at which the user provides manual inputs to the system, and body language data indicative of a body language of the user based on the video input.

13. The system of claim 12, wherein the engagement analytics engine is further configured to:
determine, based on the player activity data, a frame rate at which images are rendered by the system.

14. The system of claim 12, wherein the engagement analytics engine is further configured to:
determine, based on the player activity data, at least one quality parameter defining how images are rendered by the system.

15. A system comprising:
a plurality of servers, wherein a first server of the plurality of servers comprises:
an engagement analytics engine configured to:
generate engagement data indicative of a level of engagement associated with a set of images based on the set of images and player inputs; and
generate encoding parameters based on the engagement data; and
a video encoder configured to:
encode the set of images based on the encoding parameters.

16. The system of claim 15, further comprising:
a load balancer communicatively coupled to the first server, the load balancer being configured to:
reassign a workload associated with the set of images from the first server to a second server of the plurality of servers based on the engagement data and based on player meta information associated with a user.

17. The system of claim 16, wherein the player meta information is selected from the group consisting of: player popularity data indicative at least of an average number of viewers associated with an account of the user, a player skill level associated with the user and a game application corresponding to the set of images, user-defined graphics settings indicative at least of a prioritization of gameplay performance or graphics quality, score update data indicative of an update rate of which at least one score associated with the user and the game application, and chat room data indicative of a rate at which messages are submitted to a chat room associated with the user.

18. The system of claim 16, wherein the engagement data is selected from a group consisting of: player activity data, gameplay status data, color anomaly data, motion characterization data, and audio source data.

19. The system of claim 16, wherein the load balancer is configured to reassign the workload associated with the set of images to the second server in response the engagement data and the player meta information indicating a level of engagement.

20. The system of claim 19, wherein in response to determining that the level of engagement is low, the load balancer is configured to select the second server based on the second server having at least one of higher latency, lower demand, and lower performance compared to the first server.

21. The system of claim 19, wherein in response to determining that the level of engagement is high, the load balancer is configured to select the second server based on the second server having at least one of lower latency, higher demand, and higher performance compared to the first server.
